(19) United States
(12) Patent Application Publication
(10) Pub. No.: US 2023/0299386 A1
(43) Pub. Date: Sep. 21, 2023

(54) BATTERY COOLING SYSTEM

(71) Applicant: HONDA MOTOR CO., LTD., Tokyo (JP)

(72) Inventors: Takahiro YASUE, Saitama (JP); Soichi MORII, Saitama (JP); Yusuke MANO, Tokyo (JP); Harumi TAKEDOMI, Saitama (JP)

(73) Assignee: HONDA MOTOR CO., LTD., Tokyo (JP)

(21) Appl. No.: 18/114,636

(22) Filed: Feb. 27, 2023

(30) Foreign Application Priority Data
Mar. 18, 2022 (JP) 2022-044168

(51) Int. Cl. H01M 10/6557; H01M 10/613; H01M 10/633

(52) U.S. Cl. CPC H01M 10/6557; H01M 10/613; H01M 10/633

(57) ABSTRACT

A battery cooling system includes a battery cooling flow path, a first inlet and outlet portion of the battery cooling flow path, a second inlet and outlet portion of the battery cooling flow path, an inflow-side three-way valve, an outflow-side three-way valve, a first supply flow path configured to connect a first outlet of the inflow-side three-way valve to the first inlet and outlet portion, a second supply flow path configured to connect a second outlet of the inflow-side three-way valve to the second inlet and outlet portion, a first discharge path configured to connect the first inlet of the outflow-side three-way valve to the second inlet and outlet portion, and a second discharge path configured to connect the second inlet of the outflow-side three-way valve to the first inlet and outlet portion.

### CROSS-REFERENCE TO RELATED APPLICATIONS

This application is based on and claims priority under 35 USC 119 from Japanese Patent Application No. 2022-044168 filed on Mar. 18, 2022.

### TECHNICAL FIELD

The present disclosure relates to a battery cooling system which cools a battery.

### BACKGROUND ART

In recent years, research and development on secondary batteries which contribute to improvement in energy efficiency have been carried out to secure access to affordable, reliable, sustainable, and modern energy for more people.

As a technique related to the secondary batteries, for example, JP-A-2018-105573 discloses that a water jacket is disposed on a bottom surface of a battery case, which accommodates batteries, to cool the batteries.

However, in the technique disclosed in JP-A-2018-105573, it is difficult to uniformly cool a plurality of batteries accommodated in the battery case, and a variation in a temperature of the batteries occurs.

### SUMMARY

The present disclosure provides a battery cooling system which can prevent variations in temperatures of the plurality of batteries. The present disclosure contributes to improvement in energy efficiency.

According to an aspect of the present disclosure, there is provided a battery cooling system for cooling a plurality of battery groups, the battery cooling system including: a battery cooling flow path disposed above or below the plurality of battery groups; a first inlet and outlet portion of the battery cooling flow path; a second inlet and outlet portion of the battery cooling flow path; an inflow-side three-way valve including an inlet through which a refrigerant flows in, and a first outlet and a second outlet through which the refrigerant flows out; an outflow-side three-way valve including a first inlet and a second inlet through which the refrigerant flows in, and an outlet through which the refrigerant flows out; a first supply flow path configured to connect the first outlet of the inflow-side three-way valve to the first inlet and outlet portion; a second supply flow path configured to connect the second outlet of the inflow-side three-way valve to the second inlet and outlet portion; a first discharge path configured to connect the first inlet of the outflow-side three-way valve to the second inlet and outlet portion; and a second discharge path configured to connect the second inlet of the outflow-side three-way valve to the first inlet and outlet portion.

According to the present disclosure, it is possible to prevent variations in temperatures of a plurality of batteries, and it is possible to contribute to improvement in energy efficiency.

### BRIEF DESCRIPTION OF DRAWINGS

FIG. 1 is a cooling circuit configuration diagram of a battery cooling system according to a first embodiment of the present disclosure.

FIGS. 2A and 2B are a cooling circuit diagram illustrating a first state and a second state of the battery cooling system in FIG. 1.

FIG. 3 is a cooling circuit configuration diagram of a battery cooling system according to a second embodiment of the present disclosure.

FIGS. 4A and 4B are a cooling circuit diagram illustrating a first state and a second state of the battery cooling system in FIG. 3.

FIG. 5 is a cooling circuit configuration diagram of a battery cooling system according to a third embodiment of the present disclosure.

FIGS. 6A and 6B are a cooling circuit diagram illustrating a first state and a second state of the battery cooling system in FIG. 5.

FIG. 7 is a cooling circuit configuration diagram of a battery cooling system according to a fourth embodiment of the present disclosure.

FIGS. 8A and 8B are a cooling circuit diagram illustrating a first state and a second state of the battery cooling system in FIG. 7.

FIG. 9 is a cooling circuit diagram illustrating a first state of a battery cooling system according to a fifth embodiment of the present disclosure.

FIG. 10 is a cooling circuit diagram illustrating a second state of the battery cooling system in FIG. 9.

FIG. 11 is a cooling circuit diagram illustrating a first state of a battery cooling system according to a sixth embodiment of the present disclosure.

FIG. 12 is a cooling circuit diagram illustrating a second state of the battery cooling system in FIG. 11.

FIG. 13 is a cooling circuit diagram illustrating a first state of a battery cooling system according to a seventh embodiment of the present disclosure.

FIG. 14 is a cooling circuit diagram illustrating a second state of the battery cooling system in FIG. 13.

### DESCRIPTION OF EMBODIMENTS

Hereinafter, embodiments of a battery cooling system of the present disclosure will be described based on the accompanying drawings.

### First Embodiment

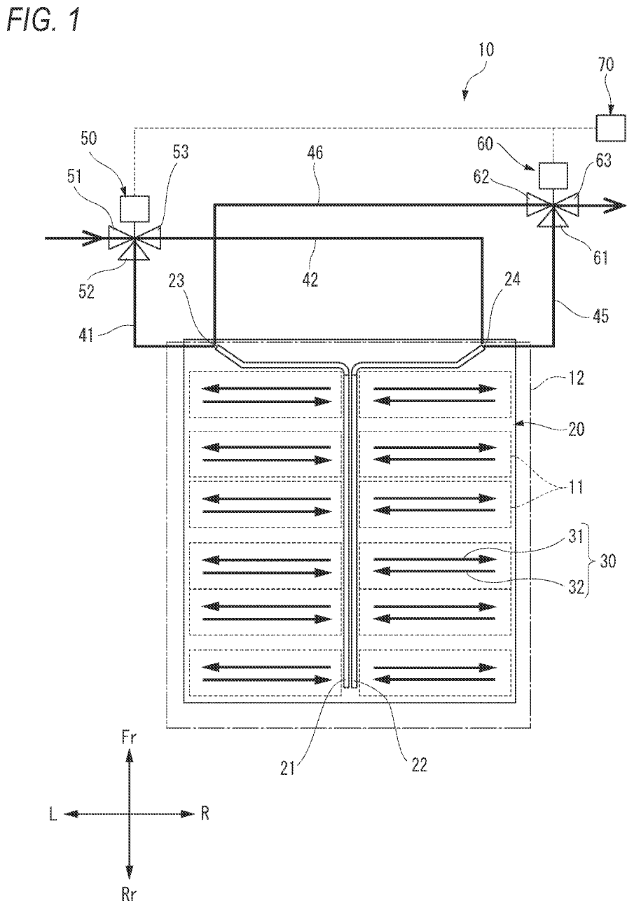

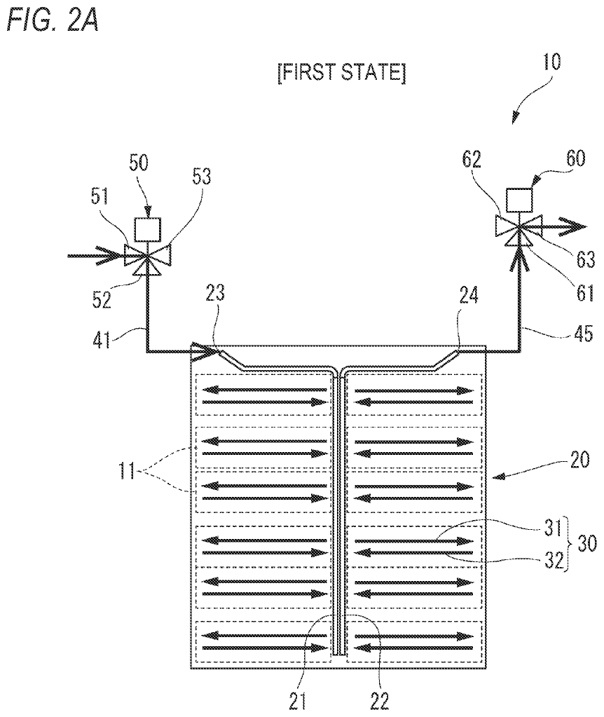

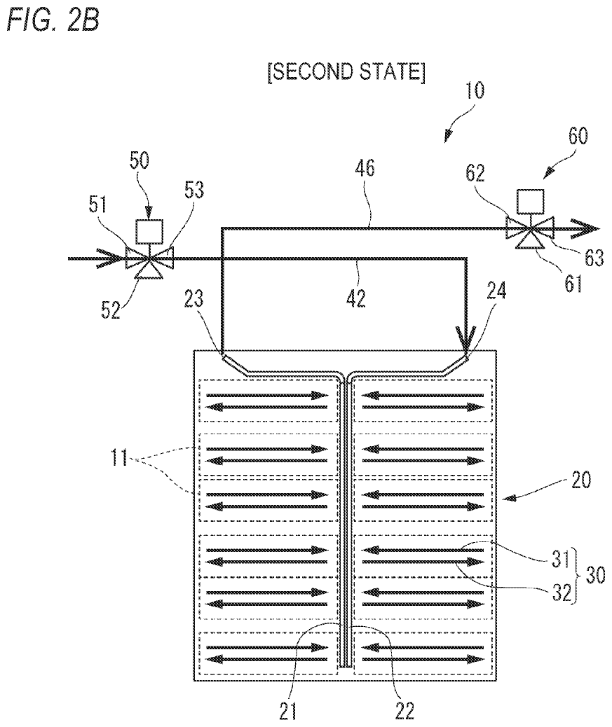

First, a battery cooling system according to a first embodiment of the present disclosure will be described with reference to FIGS. 1 to 2B. The drawings are viewed from directions of reference signs. In the following description, in order to simplify the description, for the sake of convenience, a front-rear direction, a left-right direction, and an upper-lower direction are set. In the drawings, a front side is represented by Fr, a rear side is represented by Rr, a left side is represented by L, a right side is represented by R, an upper side is represented by U, and a lower side is represented by D.

As illustrated in FIG. 1, a battery cooling system 10 according to the present embodiment is, for example, a system for cooling a plurality of battery groups 11 divided into a plurality of columns (two columns in the present embodiment) and a plurality of rows (six rows in the present embodiment) and accommodated inside a battery case 12. The battery cooling system 10 according to the present embodiment mainly includes a battery cooling flow path 20 disposed above or below the plurality of battery groups 11, an inflow-side three-way valve 50, an outflow-side three-way valve 60, and a controller 70.

The battery cooling flow path 20 includes a pair of a first inlet and outlet flow path 21 and a second inlet and outlet flow path 22 which are disposed in parallel with each other at a substantially center of the battery case 12 in a width direction and which extend in the front-rear direction. The first inlet and outlet flow path 21 includes a first inlet and outlet portion 23 through which a refrigerant can flow in or flow out at one end thereof (an upper end in FIG. 1). The second inlet and outlet flow path 22 includes a second inlet and outlet portion 24 through which the refrigerant can flow in or flow out at one end thereof (an upper end in FIG. 1). The other ends of the first inlet and outlet flow path 21 and the second inlet and outlet flow path 22 are closed.

A plurality of (six in the embodiment illustrated in FIG. 1) cooling branch pipes 30 which are connected to the first inlet and outlet flow path 21 and the second inlet and outlet flow path 22 and which extend in parallel with each other in the left-right direction are provided in the first inlet and outlet flow path 21 and the second inlet and outlet flow path 22 disposed in parallel with each other at the substantially center in the width direction.

Each cooling branch pipe 30 includes a first flow path 31 connected to the first inlet and outlet flow path 21, and a second flow path 32 connected to the second inlet and outlet flow path 22. The first flow path 31 and the second flow path 32 are connected to each other in a substantially U shape at an end on a side opposite to the first inlet and outlet flow path 21 or the second inlet and outlet flow path 22. Therefore, the refrigerant which is branched from the first inlet and outlet flow path 21 and which flows in the first flow path 31 toward a tip end direction is turned back at the end and flows in the second flow path 32 toward the second inlet and outlet flow path 22. Further, the refrigerant which is branched from the second inlet and outlet flow path 22 and which flows in the second flow path 32 toward a tip end direction is turned back at the end and flows in the first flow path 31 toward the first inlet and outlet flow path 21.

In the present embodiment, in order to improve cooling effects of the refrigerant, the first flow path 31 and the second flow path 32 are disposed along each row over the plurality of battery groups 11 arranged in the plurality of columns and the plurality of rows. Accordingly, the two refrigerants including the refrigerant which flows in the first flow path 31 in the tip end direction and the refrigerant which returns into the second flow path 32 efficiently cool the plurality of battery groups 11.

The inflow-side three-way valve 50 includes an inlet 51 through which a refrigerant supplied from a refrigerant supply source (not illustrated) flows in, and a first outlet 52 and a second outlet 53 through which the refrigerant flows out. The first outlet 52 of the inflow-side three-way valve 50 and the first inlet and outlet portion 23 of the battery cooling flow path 20 are connected by a first supply flow path 41, and the second outlet 53 of the inflow-side three-way valve 50 and the second inlet and outlet portion 24 of the battery cooling flow path 20 are connected by a second supply flow path 42.

The outflow-side three-way valve 60 includes a first inlet 61 and a second inlet 62 through which the refrigerant flows in, and an outlet 63 through which the refrigerant flows out. The first inlet 61 of the outflow-side three-way valve 60 and the second inlet and outlet portion 24 of the battery cooling flow path 20 are connected by a first discharge path 45, and the second inlet 62 of the outflow-side three-way valve 60 and the first inlet and outlet portion 23 of the battery cooling flow path 20 are connected by a second discharge path 46.

The controller 70 controls switching between the inflow-side three-way valve 50 and the outflow-side three-way valve 60. Next, control under the controller 70 will be described in detail with reference to Figs. 2A and 2B.

The controller 70 controls switching between a first state where the inlet 51 and the first outlet 52 of the inflow-side three-way valve 50 are caused to communicate with each other, the inlet 51 and the second outlet 53 of the inflow-side three-way valve 50 are disconnected from each other, the first inlet 61 and the outlet 63 of the outflow-side three-way valve 60 are caused to communicate with each other, and the second inlet 62 and the outlet 63 of the outflow-side three-way valve 60 are disconnected from each other as illustrated in FIG. 2A, and a second state where the inlet 51 and the first outlet 52 of the inflow-side three-way valve 50 are disconnected from each other, the inlet 51 and the second outlet 53 are caused to communicate with each other, the first inlet 61 and the outlet 63 of the outflow-side three-way valve 60 are disconnected from each other, and the second inlet 62 and the outlet 63 are caused to communicate with each other as illustrated in FIG. 2B.

When the battery cooling system 10 is in the first state (see FIG. 2A), the refrigerant supplied from the refrigerant supply source (not illustrated) flows into the battery cooling flow path 20 from the first inlet and outlet portion 23 via the inlet 51 and the first outlet 52 of the inflow-side three-way valve 50 and the first supply flow path 41, flows in the first inlet and outlet flow path 21 and the first flow paths 31 of the cooling branch pipes 30 connected to the first inlet and outlet flow path 21 toward the tip end direction, is turned back at the end, and flows into the second inlet and outlet flow path 22 from the second flow path 32. The refrigerant is discharged from the first inlet 61 of the outflow-side three-way valve 60 to the outlet 63 via the second inlet and outlet portion 24 of the second inlet and outlet flow path 22 and the first discharge path 45.

On the other hand, when the battery cooling system 10 is in the second state (see FIG. 2B), the refrigerant supplied from the refrigerant supply source (not illustrated) flows into the battery cooling flow path 20 from the second inlet and outlet portion 24 via the inlet 51 and the second outlet 53 of the inflow-side three-way valve 50 and the second supply flow path 42, flows into the second inlet and outlet flow path 22 and the second flow paths 32 of the cooling branch pipes 30 connected to the second inlet and outlet flow path 22 toward a tip end direction, that is, a direction opposite to the flow direction in the first state, is turned back at the end, and flows into the first inlet and outlet flow path 21 from the first flow path 31. The refrigerant is discharged from the second inlet 62 of the outflow-side three-way valve 60 to the outlet 63 via the first inlet and outlet portion 23 of the first inlet and outlet flow path 21 and the second discharge path 46.

In this way, by the controller 70 controlling the inflow-side three-way valve 50 and the outflow-side three-way valve 60 to alternately switch the flow direction of the refrigerant at, for example, predetermined time intervals, it is possible to prevent a variation in a temperature in the plurality of battery groups 11, thereby contributing to improvement in energy efficiency.

### Second Embodiment

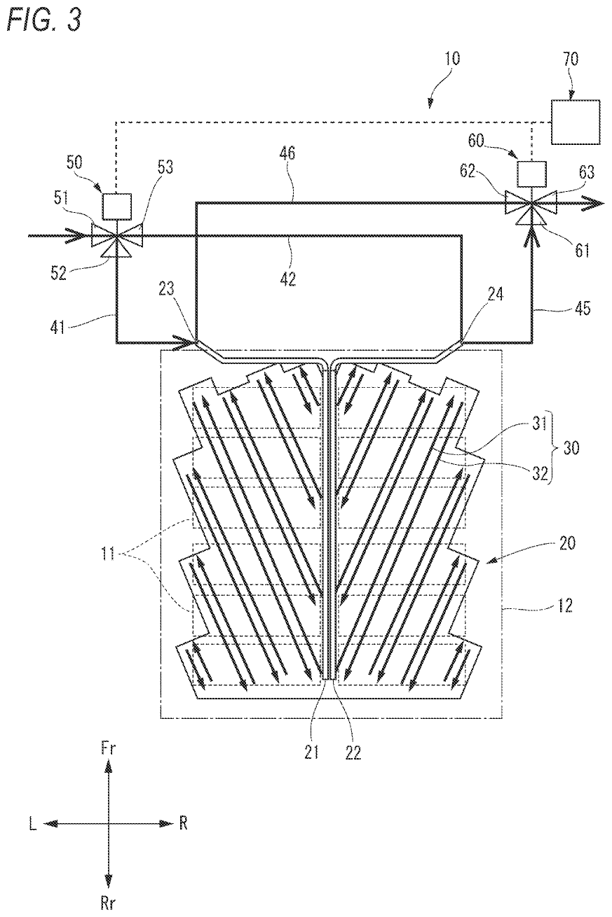

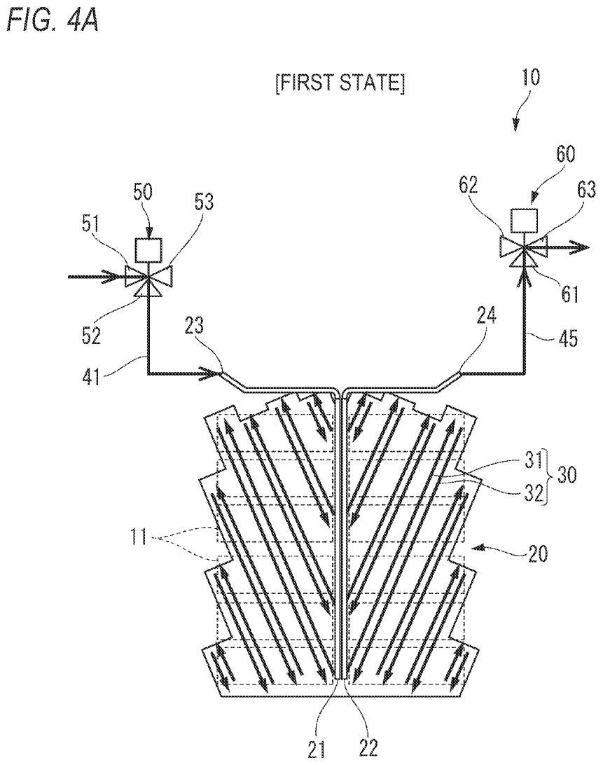

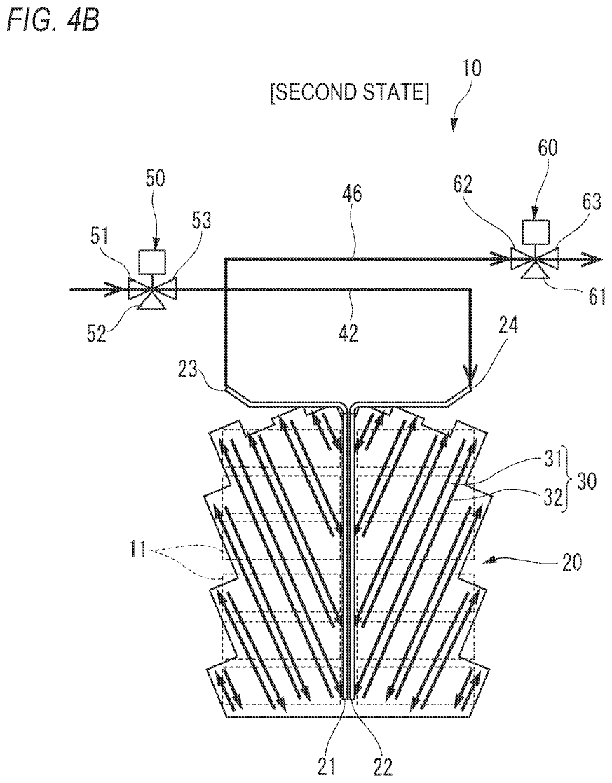

Next, a battery cooling system 10 according to a second embodiment of the present disclosure will be described with reference to FIGS. 3 to 4B. In the following description, components the same as those of the battery cooling system 10 according to the first embodiment are denoted by the same reference signs, and the description thereof will be omitted or simplified.

In the battery cooling system 10 according to the present embodiment, for example, the plurality of (seven in the embodiment illustrated in FIG. 3) cooling branch pipes 30 are provided in an inclined manner with respect to the plurality of battery groups 11 divided into a plurality of columns and a plurality of rows and accommodated inside the battery case 12. That is, the cooling branch pipes 30 are different from those of the battery cooling system 10 according to the first embodiment in that the cooling branch pipes 30 are disposed in a substantially V shape across the plurality of rows of the plurality of battery groups 11.

Specifically, the plurality of cooling branch pipes 30 having lengths different from one another are disposed in the substantially V shape on both left and right sides of the pair of the first inlet and outlet flow path 21 and the second inlet and outlet flow path 22 disposed at a center of the battery case 12 in a width direction. A reason why the lengths of the cooling branch pipes 30 are different is to make an overall shape substantially rectangular such that the cooling branch pipes 30 can be efficiently accommodated in the battery case.

Other configurations and operations of the battery cooling system 10 are similar to those of the battery cooling system 10 according to the first embodiment, and therefore description thereof will be omitted. Also, in the present embodiment, the controller 70 alternately switches between a first state illustrated in FIG. 4A and a second state illustrated in FIG. 4B at, for example, predetermined time intervals, so that it is possible to change the flow direction of the refrigerant. Accordingly, it is possible to prevent a variation in a temperature in the plurality of battery groups 11. Further, in the present embodiment, since the cooling branch pipes 30 are disposed across the plurality of rows of the plurality of battery groups 11, it is possible to further prevent a variation in a temperature of the battery groups in each column.

### Third Embodiment

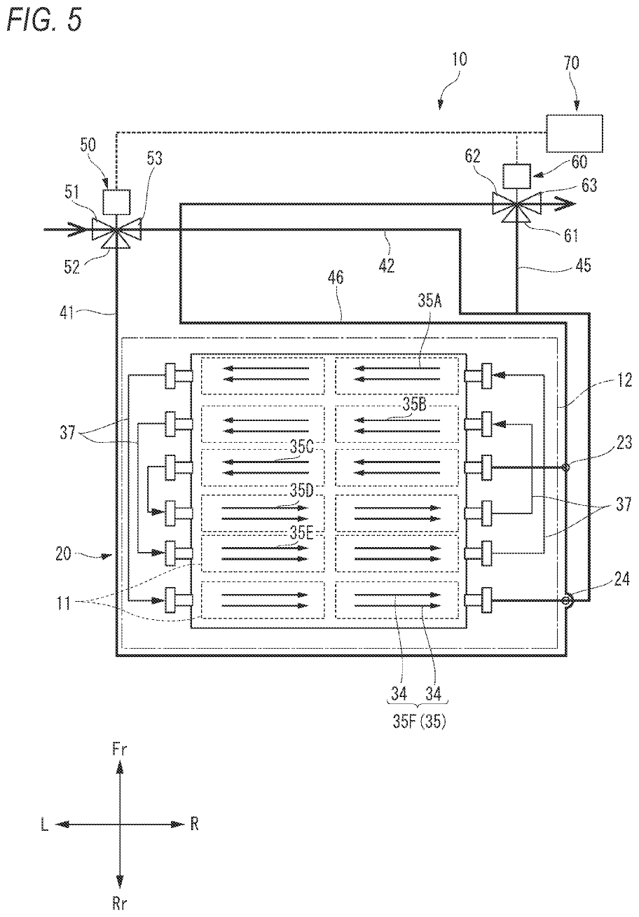

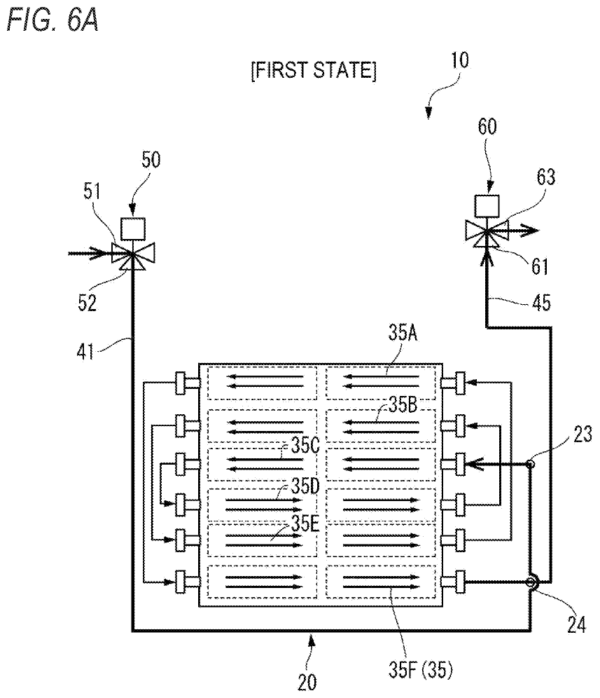

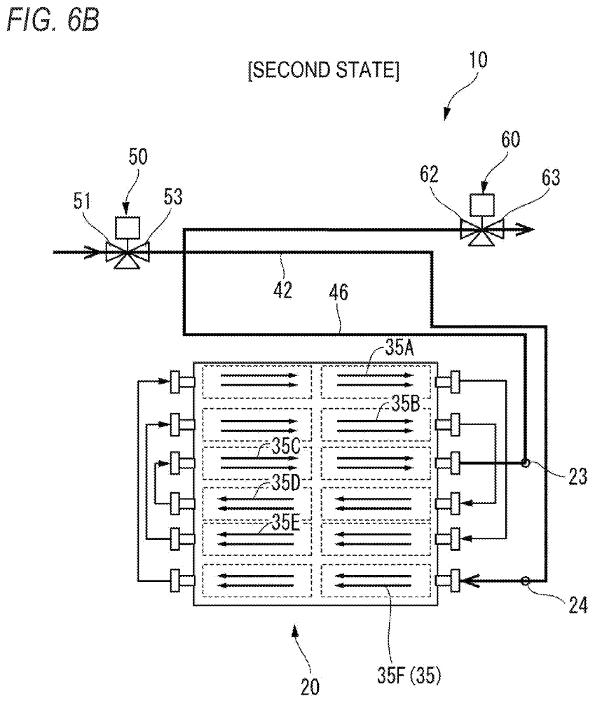

Next, a battery cooling system 10 according to a third embodiment of the present invention will be described with reference to FIGS. 5 to 6B. In the following description, components the same as those of the battery cooling system 10 according to the first embodiment are denoted by the same reference signs, and the description thereof will be omitted or simplified.

The battery cooling flow path 20 of the battery cooling system 10 according to the present embodiment includes a plurality of (six in the embodiment illustrated in FIG. 5) cooling branch pipes 35 in each of which a pair of one-way flow paths 34 are provided in parallel.

Each cooling branch pipe 35 is formed in an elongated shape having a length substantially the same as a length of the plurality of battery groups 11 in a width direction, that is, a row length of the plurality of battery groups 11, and is disposed along each row of the plurality of battery groups 11.

The cooling branch pipes 35 are the same, but for convenience of description, the cooling branch pipes 35 will be described with reference signs 35A, 35B, 35C, 35D, 35E, and 35F in an order from the cooling branch pipe 35 disposed on a front side.

The six cooling branch pipes 35 are connected in series in an order of 35C, 35D, 35B, 35E, 35A, and 35F by a plurality of coupling flow paths 37 in a left spiral shape.

Further, the cooling branch pipe 35C is connected to the first inlet and outlet portion 23, and the cooling branch pipe 35F is connected to the second inlet and outlet portion 24.

Next, operations of the battery cooling system 10 according to the present embodiment will be described with reference to Figs, 6A and 6B.

As illustrated in FIG. 6A, when the batter cooling system 10 is in a first state, a refrigerant supplied from a refrigerant supply source (not illustrated) flows into the battery cooling flow path 20 from the first inlet and outlet portion 23 via the inlet 51 and the first outlet 52 of the inflow-side three-way valve 50 and the first supply flow path 41, flows into the plurality of cooling branch pipes 35 connected in series by the plurality of coupling flow paths 37 in a left spiral shape, specifically, in an order of the cooling brand) pipes 35C, 35D, 35B, 35E, 35A, and 35F, cools the plurality of battery groups 11, then flows out from the cooling branch pipe 35F, and is discharged from the first inlet 61 of the outflow-side three-way valve 60 to the outlet 63 via the second inlet and outlet portion 24 and the first discharge path 45.

As illustrated in FIG. 6B, when the battery cooling system 10 is in a second state, the refrigerant supplied from the refrigerant supply source (not illustrated) flows into the battery cooling flow path 20 from the second inlet and outlet portion 24 via the inlet 51 and the second outlet 53 of the inflow-side three-way valve 50 and the second supply flow path 42, flows into the plurality of cooling branch pipes 35 connected in series by the plurality of coupling flow paths 37 in a right spiral shape in a direction opposite to the above-described direction, specifically, in an order of the cooling branch pipes 35F, 35A, 35E, 35B, 35D, and 35C, cools the plurality of battery groups 11, then flows out from the cooling branch pipe 35C, and is discharged from the second inlet 62 of the outflow-side three-way valve 60 to the outlet 63 via the first inlet and outlet portion 23 and the second discharge path 46.

In this way, the controller 70 controls the inflow-side three-way valve 50 and the outflow-side three-way valve 60 to alternately switch the flow direction of the refrigerant at, for example, predetermined time intervals, so that it is possible to prevent a variation in a temperature in the plurality of battery groups 11, thereby contributing to improvement in energy efficiency.

### Fourth Embodiment

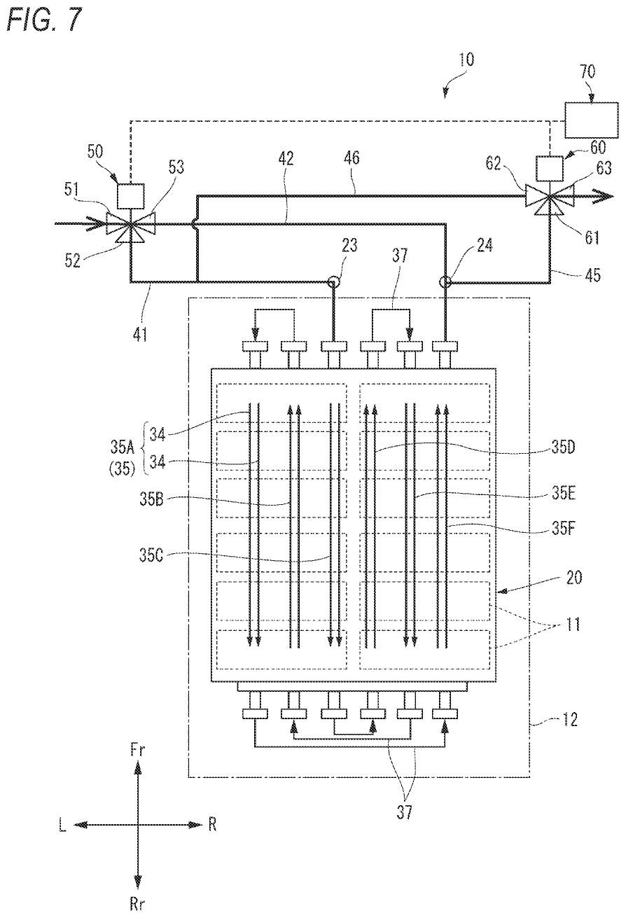

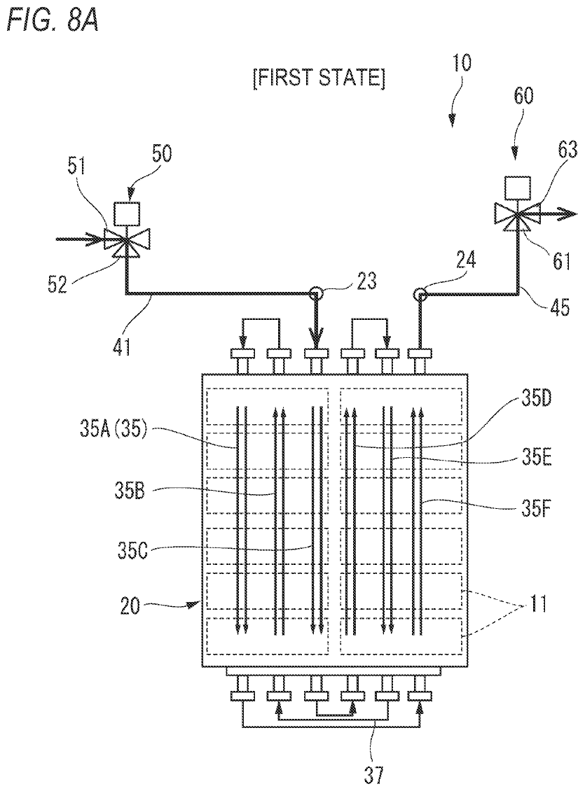

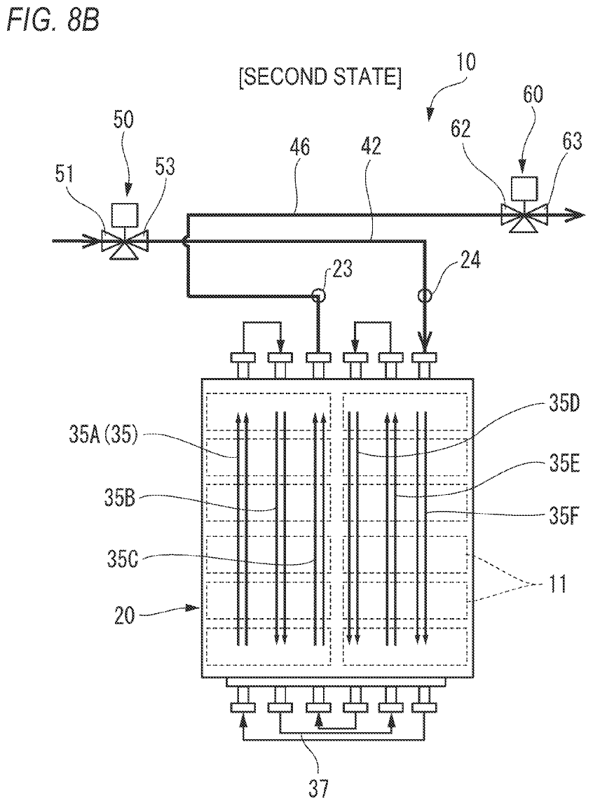

Next, a battery cooling system 10 according to a fourth embodiment of the present invention will be described with reference to FIGS. 7 to 8B. In the following description, components the same as those of the battery cooling system 10 according to the first embodiment are denoted by the same reference signs, and the description thereof will be omitted or simplified.

The battery cooling flow path 20 of the battery cooling system 10 according to the present embodiment includes a plurality of (six in the embodiment illustrated in FIG. 7) cooling branch pipes 35 in each of which the pair of one-way flow paths 34 are provided in parallel. The plurality of cooling branch pipes 35 extend in a column direction (front-rear direction) and are disposed in alignment in the left-right direction with respect to the plurality of battery groups 11 divided and disposed in a plurality of columns and a plurality of rows.

Hereinafter, for convenience of description, similar to the battery cooling flow path 20 according to the third embodiment, the cooling branch pipes 35 will be described with reference signs 35A, 35B, 35C, 35D, 35E, and 35F in an order from the cooling branch pipe 35 disposed on a left side in the drawing.

The six cooling branch pipes 35 are connected in series in an order of the cooling branch pipes 35C, 35D, 35E, 35B, 35A, and 35F by the coupling flow paths 37 in a zigzag shape.

The cooling branch pipe 35C is connected to the first inlet and outlet portion 23, and the cooling branch pipe 35F is connected to the second inlet and outlet portion 24.

Next, operations of the battery cooling system 10 according to the present embodiment will be described with reference to FIGS. 8A and 8B.

As illustrated in FIG. 8A, when the battery cooling system 10 is in a first state, a refrigerant supplied from a refrigerant supply source (not illustrated) flows into the battery cooling flow path 20 from the first inlet and outlet portion 23 via the inlet 51 and the first outlet 52 of the inflow-side three-way valve 50 and the first supply flow path 41, flows in the plurality of cooling branch pipes 35 connected in series by the plurality of coupling flow paths 37 in an order of the cooling branch pipes 35C, 35D, 35E, 35B, 35A, and 35F, cools the plurality of battery groups 11, then flows out from the cooling branch pipe 35F, and is discharged from the first inlet 61 of the outflow-side three-way valve 60 to the outlet 63 via the second inlet and outlet portion 24 and the first discharge path 45.

As illustrated in FIG. 8B, when the battery cooling system 10 is in a second state, the refrigerant supplied from the refrigerant supply source (not illustrated) flows into the battery cooling flow path 20 from the second inlet and outlet portion 24 via the inlet 51 and the second outlet 53 of the inflow-side three-way valve 50 and the second supply flow path 42, flows in the plurality of cooling branch pipes 35 connected in series by the plurality of coupling flow paths 37 in a direction opposite to the above-described direction in an order of the cooling branch pipes 35F, 35A, 35B, 35E, 35D, and 35C, cools the plurality of battery groups 11, then flows out from the cooling branch pipe 35C, and is discharged from the second inlet 62 of the outflow-side three-way valve 60 to the outlet 63 via the first inlet and outlet portion 23 and the second discharge path 46.

In this way, the controller 70 controls the inflow-side three-way valve 50 and the outflow-side three-way valve 60 to alternately switch the flow direction of the refrigerant at, for example, predetermined time intervals, so that it is possible to prevent a variation in a temperature in the plurality of battery groups 11, thereby contributing to improvement in energy efficiency.

### Fifth Embodiment

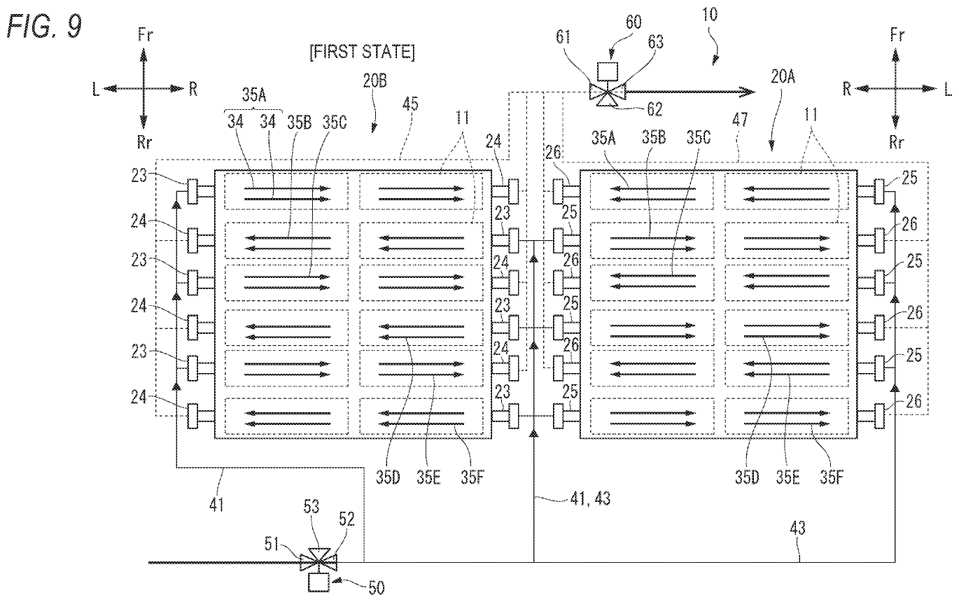

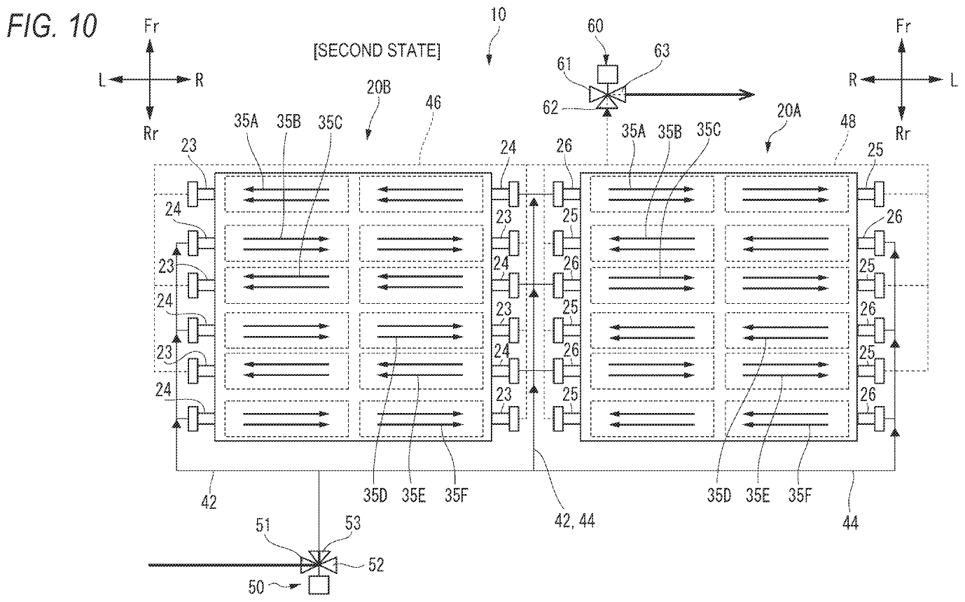

Next, a battery cooling system 10 according to a fifth embodiment of the present invention will be described with reference to FIGS. 9 and 10.

The battery cooling system 10 according to the present embodiment includes an upper battery cooling flow path 20A disposed on an upper surface of the battery group 11 and a lower battery cooling flow path 20B disposed on a lower surface of the battery group 11, and cools the plurality of battery groups 11 by sandwiching the plurality of battery groups 11 from the upper-lower direction. The upper battery cooling flow path 20A and the lower battery cooling flow path 20B each include the plurality of (in the embodiment illustrated in FIG. 9, six for each of the battery cooling flow paths 20A and 20B) cooling branch pipes 35 in each of which the pair of one-way flow paths 34 are provided in parallel. The plurality of cooling branch pipes 35 extend in the left-right direction (row direction of the plurality of battery groups 11) and are disposed in alignment and in parallel in the front-rear direction with respect to the plurality of battery groups 11 divided and disposed in a plurality of columns and a plurality of rows.

For convenience of description, the cooling branch pipes 35 of the upper battery cooling flow path 20A and the lower battery cooling flow path 20B will be described with reference signs 35A, 35B, 35C, 35D, 35E, and 35F in an order from the cooling branch pipe 35 disposed on a front side (an upper side in the drawing). FIGS. 9 and 10 illustrate the upper battery cooling flow path 20A in a state of being developed by 180°. That is, the upper battery cooling flow path 20A illustrates a diagram viewed from a lower side, and the lower battery cooling flow path 20B illustrates a diagram viewed from an upper side.

As illustrated in FIG. 9, when the battery cooling system 10 is in a first state, a refrigerant supplied from a refrigerant supply source (not illustrated) flows into the battery cooling flow path 20B from the first inlet and outlet portions 23 of the cooling branch pipes 35A, 35C, and 35E and the cooling branch pipes 35B, 35D, and 35F of the lower battery cooling flow path 20B via the inlet 51 and the first outlet 52 of the inflow-side three-way valve 50 and the first supply flow path 41.

The refrigerant, which flows in the cooling branch pipes 35 of the lower battery cooling flow path 20B to cool the plurality of battery groups 11, is discharged from the second inlet and outlet portions 24 of the cooling branch pipes 35 via the first discharge path 45 to the outlet 63 from the first inlet 61 of the outflow-side three-way valve 60.

The refrigerant supplied from the inflow-side three-way valve 50 flows into the upper battery cooling flow path 20A from third inlet and outlet portions 25 of the cooling branch pipes 35A, 35C, and 35E and the cooling branch pipes 35B, 35D, and 35F of the upper battery cooling flow path 20A via a third supply flow path 43 which is common to the first supply flow path 41 or which branches from the first supply flow path 41.

The refrigerant, which flows in the cooling branch pipes 35 of the upper battery cooling flow path 20A to cool the plurality of battery groups 11, is discharged from fourth inlet and outlet portions 26 of the cooling branch pipes 35 via a third discharge path 47 to the outlet 63 from the first inlet 61 of the outflow-side three-way valve 60.

As illustrated in FIG. 10, when the battery cooling system 10 is in a second state, the refrigerant supplied from the refrigerant supply source (not illustrated) flows into the battery cooling flow path 20B from the second inlet and outlet portions 24 of the cooling branch pipes 35B, 35D, and 35F and the cooling branch pipes 35A, 35C, and 35E of the lower battery cooling flow path 20B via the inlet 51 and the second outlet 53 of the inflow-side three-way valve 50 and the second supply flow path 42.

The refrigerant, which flows in the cooling branch pipes 35 of the lower battery cooling flow path 20B to cool the plurality of battery groups 11, is discharged from the first inlet and outlet portions 23 of the cooling branch pipes 35 via the second discharge path 46 to the outlet 63 from the second inlet 62 of the outflow-side three-way valve 60.

The refrigerant supplied from the inflow-side three-way valve 50 flows into the upper battery cooling flow path 20A from the fourth inlet and outlet portions 26 of the cooling branch pipes 35B, 35D, and 35F and the cooling branch pipes 35A, 35C, and 35E of the upper battery cooling flow path 20A via the fourth supply flow path 44 which is common to the second supply flow path 42 or which branches from the second supply flow path 42.

The refrigerant, which flows in the cooling branch pipes 35 of the upper battery cooling flow path 20A to cool the plurality of battery groups 11, is discharged from the third inlet and outlet portions 25 of the cooling branch pipes 35 via a fourth discharge path 48 to the outlet 63 from the second inlet 62 of the outflow-side three-way valve 60. In the battery cooling system 10 according to the fifth embodiment, the refrigerant which flows in the upper battery cooling flow path 20A and the refrigerant which flows in the lower battery cooling flow path 20B may be set in opposite directions. Accordingly, it is possible to further prevent a variation in a temperature in the plurality of battery groups 11.

### Sixth Embodiment

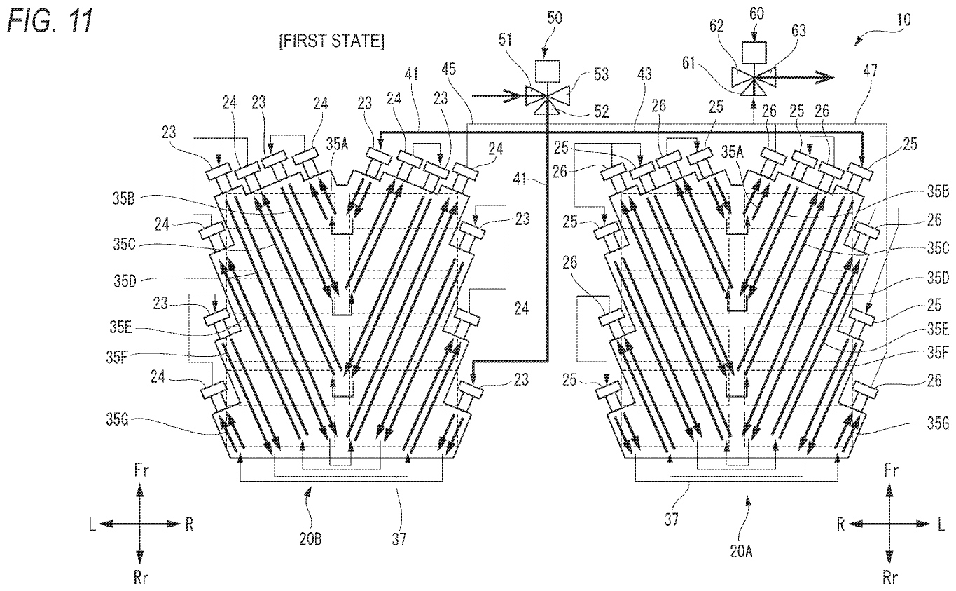

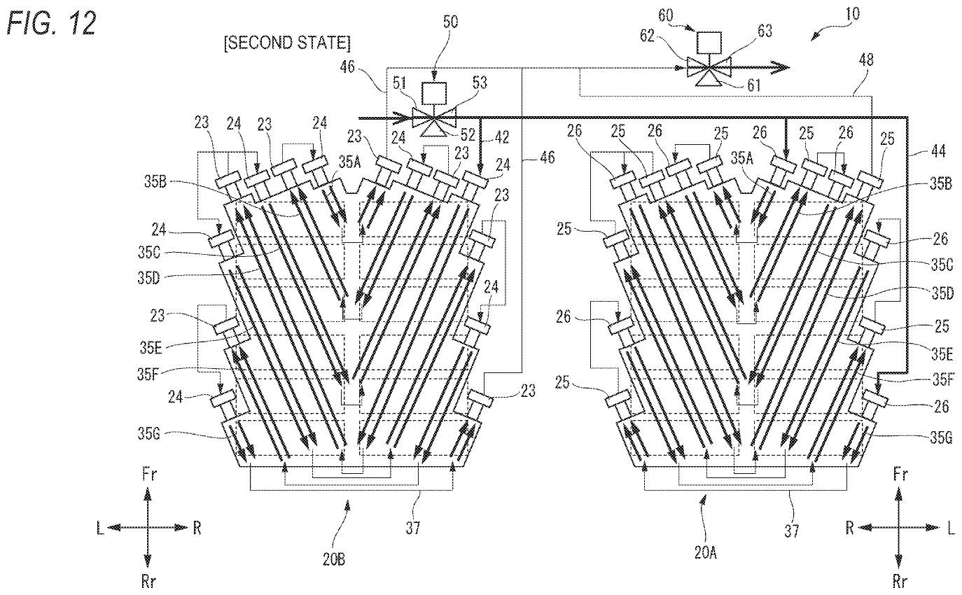

Next, a battery cooling system 10 according to a sixth embodiment of the present invention will be described with reference to FIGS. 11 and 12.

The battery cooling system 10 according to the present embodiment includes the upper battery cooling flow path 20A disposed on an upper surface of the battery group 11 and the lower battery cooling flow path 20B disposed on a lower surface of the battery group 11, and cools the plurality of battery groups 11 by sandwiching the plurality of battery groups 11 from the upper-lower direction. The upper battery cooling flow path 20A and the lower battery cooling flow path 20B each include the plurality of cooling branch pipes 35 in each of which the pair of one-way flow paths 34 are provided in parallel and which are formed in a substantially V shape. Some cooling branch pipes 35 are formed in the substantially V shape by the coupling flow paths 37 connecting the cooling branch pipes 35 to one another.

For convenience of description, the cooling branch pipes 35 of the upper battery cooling flow path 20A and the lower battery cooling flow path 20B will be described with reference signs 35A, 35B, 35C, 35D, 35E, 35F, and 35G in an order from the small V-shaped cooling branch pipe 35 disposed on a front side (an upper side in the drawing).

As illustrated in FIG. 11, when the battery cooling system 10 is in a first state, a refrigerant supplied from a refrigerant supply source (not illustrated) flows into the battery cooling flow path 20B from the first inlet and outlet portions 23 of the cooling branch pipes 35A and 35G of the lower battery cooling flow path 20B via the inlet 51 and the first outlet 52 of the inflow-side three-way valve 50 and the first supply flow path 41.

The refrigerant which flows in from the first inlet and outlet portion 23 of the cooling branch pipe 35A of the lower battery cooling flow path 20B flows in the cooling branch pipes 35A, 35B, and 35C in a V shape, and flows in from the second inlet and outlet portion 24 of the cooling branch pipe 35C and the first inlet and outlet portion 23 of the cooling branch pipe 35D. On the other hand, the refrigerant which flows in from the first inlet and outlet portion 23 of the cooling branch pipe 35G flows through the cooling branch pipes 35G, 35F, and 35E in the V shape, and merges into the first inlet and outlet portion 23 of the cooling branch pipe 35D from the second inlet and outlet portion 24 of the cooling branch pipe 35E. The merged refrigerant is discharged from the second inlet and outlet portion 24 of the cooling branch pipe 35D via the first discharge path 45 to the outlet 63 from the first inlet 61 of the outflow-side three-way valve 60.

The refrigerant supplied from the inflow-side three-way valve 50 flows into the upper battery cooling flow path 20A from the third inlet and outlet portion 25 of the cooling branch pipe 35D of the upper battery cooling flow path 20A via the third supply flow path 43 which branches from the first supply flow path 41.

The refrigerant which flows in from the third inlet and outlet portion 25 of the cooling branch pipe 35D of the upper battery cooling flow path 20A branches at the fourth inlet and outlet portion 26 of the cooling branch pipe 35D. One part of the refrigerant flows in the cooling branch pipes 35C, 35B, and 35A in the V shape, and is discharged from the fourth inlet and outlet portion 26 of the cooling branch pipe 35A via the third discharge path 47 to the outlet 63 from the first inlet 61 of the outflow-side three-way valve 60. The other part of the refrigerant which branches in the cooling branch pipe 35D flows in the cooling branch pipes 35E, 35F, and 35G in the V shape, and is discharged from the fourth inlet and outlet portion 26 of the cooling branch pipe 35G via the third discharge path 47 to the outlet 63 from the first inlet 61 of the outflow-side three-way valve 60.

As illustrated in FIG. 12, when the battery cooling system 10 is in a second state, the refrigerant flows into the lower battery cooling flow path 20B from the second inlet and outlet portion 24 of the cooling branch pipe 35D of the lower battery cooling flow path 20B via the inlet 51 and the second outlet 53 of the inflow-side three-way valve 50 and the second supply flow path 42, flows through the cooling branch pipes 35D, 35C, 35B, and 35A and the cooling branch pipes 35E, 35F, and 35G in the V shape, and is discharged from the first inlet and outlet portions 23 of the cooling branch pipes 35A and 35G via the second discharge path 46 to the outlet 63 from the second inlet 62 of the outflow-side three-way valve 60.

The refrigerant supplied from the inflow-side three-way valve 50 flows in from the fourth inlet and outlet portions 26 of the cooling branch pipes 35A and 35G of the upper battery cooling flow path 20A via the fourth supply flow path 44 which branches from the second supply flow path 42. The refrigerant which flows in from the fourth inlet and outlet portion 26 of the cooling branch pipe 35A flows through the cooling branch pipes 35A, 35B, 35C, and 35D in the V shape. The refrigerant which flows in from the fourth inlet and outlet portion 26 of the cooling branch pipe 35G flows through the cooling branch pipes 35G, 35F, and 35E in the V shape, merges into the cooling branch pipe 35D, and is discharged from the third inlet and outlet portion 25 of the cooling branch pipe 35D via the fourth discharge path 48 to the outlet 63 from the second inlet 62 of the outflow-side three-way valve 60.

In this way, the cooling branch pipes 35 are disposed in the V shape across the plurality of battery groups 11, and the flow direction of the refrigerant is alternately switched. Therefore, it is possible to prevent a variation in a temperature in the plurality of battery groups 11. In the battery cooling system 10 according to the sixth embodiment, the refrigerant which flows through the upper battery cooling flow path 20A and the refrigerant which flows through the lower battery cooling flow path 20B may be set in opposite directions. Accordingly, it is possible to further prevent the variation in the temperature in the plurality of battery groups 11.

### Seventh Embodiment

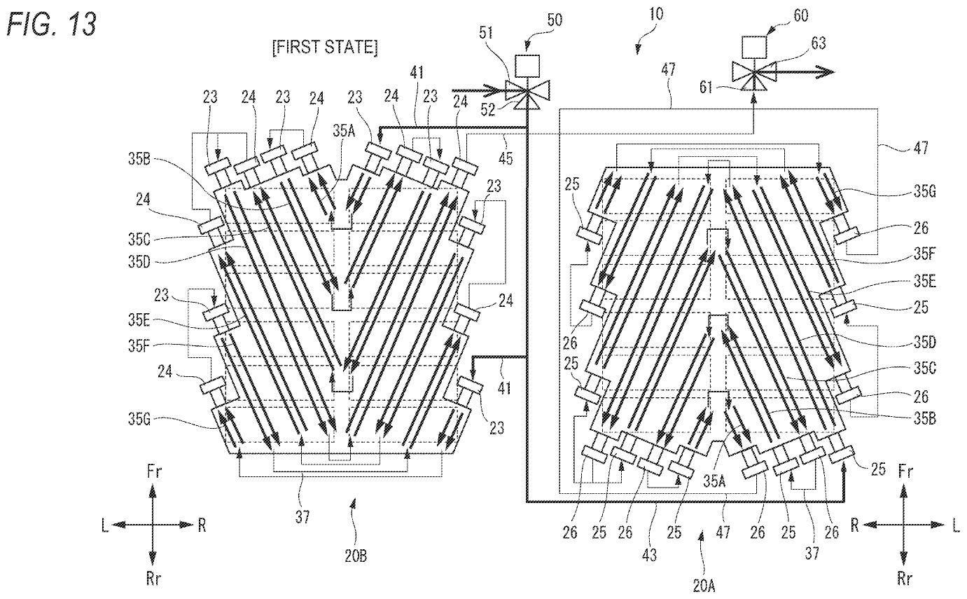

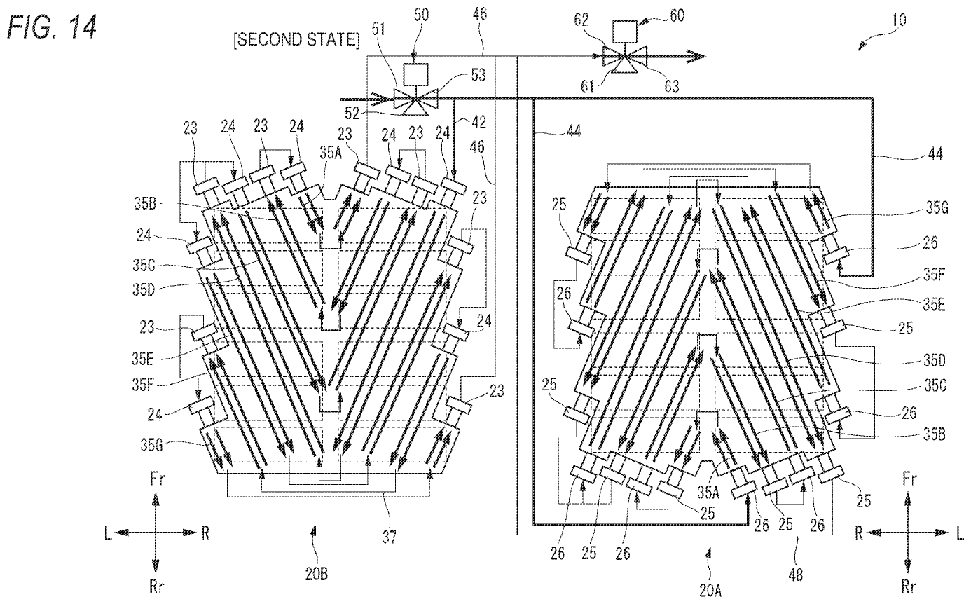

Next, a battery cooling system 10 according to a seventh embodiment of the present invention will be described with reference to FIGS. 13 and 14. The battery cooling system 10 according to the present embodiment includes the upper battery cooling flow path 20A and the lower battery cooling flow path 20B. Each cooling branch pipe 35 of the lower battery cooling flow path 20B is disposed in a V shape, and each cooling branch pipe 35 of the upper battery cooling flow path 20A is disposed in an inverted V shape in a direction opposite to that of the lower battery cooling flow path 20B.

As illustrated in FIG. 13, when the battery cooling system 10 is in a first state, a refrigerant supplied from the inflow-side three-way valve 50 flows in from the cooling branch pipes 35A and 35G of the lower battery cooling flow path 20B via the first supply flow path 41, flows in the cooling branch pipes in the V shape, merges into the first inlet and outlet portion 23 of the cooling branch pipe 35D, and then is discharged from the second inlet and outlet portion 24 of the cooling branch pipe 35D via the first discharge path 45 to the outlet 63 of the outflow-side three-way valve 60.

On the other hand, the refrigerant supplied from the inflow-side three-way valve 50 flows into the upper battery cooling flow path 20A from the cooling branch pipe 35D of the upper battery cooling flow path 20A via the third supply flow path 43, flows in the cooling branch pipes in the inverted V shape in a direction opposite to that of the lower battery cooling flow path 20B, and is discharged from the cooling branch pipes 35A and 35G via the third discharge path 47 to the outlet 63 of the outflow-side three-way valve 60.

As illustrated in FIG. 14, when the battery cooling system 10 is in a second state, the refrigerant supplied from the inflow-side three-way valve 50 flows in from the cooling branch pipe 35D of the lower battery cooling flow path 20B via the second supply flow path 42, flows in the cooling branch pipes in the V shape, and is discharged from the first inlet and outlet portions 23 of the cooling branch pipes 35A and 35G via the second discharge path 46 to the outlet 63 of the outflow-side three-way valve 60.

The refrigerant supplied from the inflow-side three-way valve 50 flows into the upper battery cooling flow path 20A from the fourth inlet and outlet portions 26 of the cooling branch pipes 35A and 35G of the upper battery cooling flow path 20A via the fourth supply flow path 44 which branches from the second supply flow path 42, flows in the cooling branch pipes in the inverted V shape in a direction opposite to that of the lower battery cooling flow path 20B, and is discharged from the cooling branch pipe 35D via the fourth discharge path 48 to the outlet 63 of the outflow-side three-way valve 60.

In the battery cooling system 10 according to the present embodiment, the directions of the cooling branch pipes 35 of the upper battery cooling flow path 20A and the lower battery cooling flow path 20B are different from each other in the V shape and the inverted V shape. The upper and lower battery cooling flow paths 20A and 20B are overlapped, so that the V-shaped cooling branch pipes 35 and the inverted V-shaped cooling branch pipes 35 intersect with each other. Therefore, the battery group 11 can be subdivided and cooled. Therefore, it is possible to further prevent a variation in a temperature in the plurality of battery groups 11 Other configurations are similar to those of the battery cooling system 10 according to the sixth embodiment, and therefore detailed description thereof is omitted.

Although various embodiments have been described above with reference to the drawings, it is needless to say that the present invention is not limited to these examples. It will be apparent to those skilled in the art that various changes and modifications may be conceived within the scope of the claims. It is also understood that the various changes and modifications belong to the technical scope of the present invention. Further, the components in the embodiments described above may be combined freely within a range not departing from the spirit of the invention.

In the present specification, at least the following matters are described. Corresponding components in the above embodiment are shown in parentheses. However, the present invention is not limited thereto.

(1) A battery cooling system (the battery cooling system 10) for cooling a plurality of battery groups (the battery groups 11), the battery cooling system including:
a battery cooling flow path (the battery cooling flow path 20) disposed above or below the plurality of battery groups;
a first inlet and outlet portion (the first inlet and outlet portion 23) of the battery cooling flow path;
a second inlet and outlet portion (the second inlet and outlet portion 24) of the battery cooling flow path;
an inflow-side three-way valve (the inflow-side three-way valve 50) including an inlet (the inlet 51) through which a refrigerant flows in, and a first outlet (the first outlet 52) and a second outlet (the second outlet 53) through which the refrigerant flows out;
an outflow-side three-way valve (the outflow-side three-way valve 60) including a first inlet (the first inlet 61) and a second inlet (the second inlet 62) through which the refrigerant flows in, and an outlet (the outlet 63) through which the refrigerant flows out;
a first supply flow path (the first supply flow path 41) configured to connect the first outlet of the inflow-side three-way valve to the first inlet and outlet portion;
a second supply flow path (the second supply flow path 42) configured to connect the second outlet of the inflow-side three-way valve to the second inlet and outlet portion;
a first discharge path (the first discharge path 45) configured to connect the first inlet of the outflow-side three-way valve to the second inlet and outlet portion; and
a second discharge path (the second discharge path 46) configured to connect the second inlet of the outflow-side three-way valve to the first inlet and outlet portion,

According to (1), since it is possible to switch a flow direction of the refrigerant which flows through the battery cooling flow path by using the two three-way valves, a variation in a temperature in the plurality of battery groups can be prevented.

(2) The battery cooling system according to (1), further including:
a controller (the controller 70) configured to control the inflow-side three-way valve and the outflow-side three-way valve, in which:
the controller switches between
first state where the inflow-side three-way valve is controlled such that the inlet and the first outlet are caused to communicate with each other and the inlet and the second outlet are disconnected from each other, and the outflow-side three-way valve is controlled such that the first inlet and the outlet are caused to communicate with each other and the second inlet and the outlet are disconnected from each other, and
a second state where the inflow-side three-way valve is controlled such that the inlet and the first outlet are disconnected from each other and the inlet and the second outlet are caused to communicate with each other, and the outflow-side three-way valve is controlled such that the first inlet and the outlet are disconnected from each other and the second inlet and the outlet are caused to communicate with each other.

According to (2), by the controller switching between the first state and the second state, it is possible to switch the flow direction of the refrigerant which flows through the battery cooling flow path.

(3) The battery cooling system according to (1) or (2), in which:
the plurality of battery groups are divided and disposed in a plurality of columns and a plurality of rows; and
the battery cooling flow path includes:
   a first inlet and outlet flow path (the first inlet and outlet flow path 21) connected to the first inlet and outlet portion;
   a second inlet and outlet flow path (the second inlet and outlet flow path 22) connected to the second inlet and outlet portion;
   a plurality of first flow paths (the first flow paths 31) to which the refrigerant is supplied from the first inlet and outlet flow path and which cool battery groups in each row; and
   a plurality of second flow paths (the second flow paths 32) configured to cool the battery groups in each row and discharge the refrigerant to the second inlet and outlet flow path.

According to (3), it is possible to prevent a variation in a temperature in battery groups in each column.

(4) The battery cooling system according to (1) or (2), in which:
the plurality of battery groups are divided and disposed in a plurality of columns and a plurality of rows; and
the battery cooling flow path includes:
   a first inlet and outlet flow path (the first inlet and outlet flow path 21) connected to the first inlet and outlet portion;
   a second inlet and outlet flow path (the second inlet and outlet flow path 22) connected to the second inlet and outlet portion;
   a plurality of first flow paths (the first flow paths 31) to which the refrigerant is supplied from the first inlet and outlet flow path, and which obliquely extend across battery groups in a plurality of columns from the first inlet and outlet flow path to cool the battery groups in the plurality of columns and
   a plurality of second flow paths (the second flow paths 32) which obliquely extend across the battery groups in the plurality of columns to cool the battery groups in the plurality of columns, and which are configured to discharge the refrigerant to the second inlet and outlet flow path.

According to (4), it is possible to prevent a variation in a temperature in the battery groups in each column.

(5) The battery cooling system according to (1) or (2), in which:
the plurality of battery groups are divided and disposed in a plurality of columns and a plurality of rows; and the battery cooling flow path includes:
   a plurality of one-way flow paths (the one-way flow paths 34) configured to cool battery groups in each row; and
   a plurality of coupling flow paths (the coupling flow paths 37) configured to couple the one-way flow paths to one another to connect the plurality of one-way flow paths in series.

According to (5), the first inlet and outlet flow path and the second inlet and outlet flow path can be unnecessary.

(6) The battery cooling system according to (1) or (2), in which:
the plurality of battery groups are divided and disposed in a plurality of columns and a plurality of rows; and
the battery cooling flow path includes:
   a plurality of one-way flow paths configured to cool battery groups in a plurality of columns; and
   a plurality of coupling flow paths configured to couple the one-way flow paths to one another to connect the plurality of one-way flow paths in series.

According to (6), the first inlet and outlet flow path and the second inlet and outlet flow path can be unnecessary.

(7) The battery cooling system according to any one of (1) to (6), further including:
an upper battery cooling flow path (the upper battery cooling flow path 20A) disposed above the plurality of battery groups; and
a lower battery cooling flow path (the lower battery cooling flow path 20B) disposed below the plurality of battery groups, in which
either one of the upper battery cooling flow path and the lower battery cooling flow path is the battery cooling flow path.

According to (7), since the plurality of battery groups can be cooled from an upper-lower direction, a temperature difference between top and bottom of the battery can be prevented.

(8) The battery cooling system according to (7), in which
the upper battery cooling flow path and the lower battery cooling flow path are configured to switch a flow direction of the refrigerant.

According to (8), the temperature difference between the top and the bottom of the battery can be further prevented.

(9) The battery cooling system according to (7) or (8), in which
the other of the upper battery cooling flow path and the lower battery cooling flow path is configured such that the refrigerant flows in a direction opposite to the flow direction of the refrigerant in the one battery cooling flow path.

According to (9), the temperature difference between the top and the bottom of the battery can be prevented.

(10) The battery cooling system according to (8) or (9), in which
the other of the upper battery cooling flow path and the lower battery cooling flow path includes:
   the other battery cooling flow path;
   a third inlet and outlet portion (the third inlet and outlet portion 25) of the other battery cooling flow path;
   a fourth inlet and outlet portion (the fourth inlet and outlet portion 26) of the other battery cooling flow path;
   a third supply flow path (the third supply flow path 43) configured to connect the first outlet of the in-flow-side three-way valve to the third inlet and outlet portion;
   a fourth supply flow path (the fourth supply flow path 44) configured to connect the second outlet of the inflow-side three-way valve to the fourth inlet and outlet portion;
   a third discharge path (the third discharge path 47) configured to connect the first inlet of the outflow-side three-way valve to the fourth inlet and outlet portion; and
   a fourth discharge path (the fourth discharge path 48) configured to connect the second inlet of the outflow-side three-way valve to the third inlet and outlet portion.

According to (10), the two three-way valves can be used in common in the upper and lower battery cooling flow paths, and the number of components can be reduced.

What is claimed is:

1. A battery cooling system for cooling a plurality of battery groups, the battery cooling system comprising:
a battery cooling flow path disposed above or below the plurality of battery groups;
a first inlet and outlet portion of the battery cooling flow path;
a second inlet and outlet portion of the battery cooling flow path;
an inflow-side three-way valve including an inlet through which a refrigerant flows in, and a first outlet and a second outlet through which the refrigerant flows out;
an outflow-side three-way valve including a first inlet and a second inlet through which the refrigerant flows in, and an outlet through which the refrigerant flows out;
a first supply flow path configured to connect the first outlet of the inflow-side three-way valve to the first inlet and outlet portion;
a second supply flow path configured to connect the second outlet of fine inflow-side three-way valve to the second inlet and outlet portion;
a first discharge path configured to connect the first inlet of the outflow-side three-way valve to the second inlet and outlet portion; and
a second discharge path configured to connect the second inlet of the outflow-side three-way valve to the first inlet and outlet portion.

2. The battery cooling system according to claim 1, further comprising:
a controller configured to control the inflow-side three-way valve and the outflow-side three-way valve, wherein:
the controller switches between:
a first state where the inflow-side three-way valve is controlled such that the inlet and the first outlet are caused to communicate with each other and the inlet and the second outlet are disconnected from each other, and the outflow-side three-way valve is controlled such that the first inlet and the outlet are caused to communicate with each other and the second inlet and the outlet are disconnected from each other; and
a second state where the inflow-side three-way valve is controlled such that the inlet and the first outlet are disconnected from each other and the inlet and the second outlet are caused to communicate with each other, and the outflow-side three-way valve is controlled such that the first inlet and the outlet are disconnected from each other and the second inlet and the outlet are caused to communicate with each other.

3. The battery cooling system according to claim 1, wherein:
the plurality of battery groups are divided and disposed in a plurality of columns and a plurality of rows; and
the battery cooling flow path includes:
a first inlet and outlet flow path connected to the first inlet and outlet portion;
a second inlet and outlet flow path connected to the second inlet and outlet portion;
a plurality of first flow paths to which the refrigerant is supplied from the first inlet and outlet flow path and which cool battery groups in each row; and
a plurality of second flow paths configured to cool the battery groups in each row and discharge the refrigerant to the second inlet and outlet flow path.

4. The battery cooling system according to claim I, wherein:
the plurality of battery groups are divided and disposed in a plurality of columns and a plurality of rows; and
the battery cooling flow path includes:
a first inlet and outlet flow path connected to the first inlet and outlet portion;
a second inlet and outlet flow path connected to the second inlet and outlet portion;
a plurality of first flow paths to which the refrigerant is supplied from the first inlet and outlet flow path, and which obliquely extend across battery groups in a plurality of columns from the first inlet and outlet flow path to cool the battery groups in the plurality of columns; and
a plurality of second flow paths which obliquely extend across the battery groups in the plurality of columns to cool the battery groups in the plurality of columns, and which are configured to discharge the refrigerant to the second inlet and outlet flow path.

5. The battery cooling system according to claim 1, wherein:
the plurality of battery groups are divided and disposed in a plurality of columns and a plurality of rows; and
the battery cooling flow path includes:
a plurality of one-way flow paths configured to cool battery groups in each row; and
a plurality of coupling flow paths configured to couple the one-way flow paths to one another to connect the plurality of one-way flow paths in series.

6. The battery cooling system according to claim 1, wherein:
the plurality of battery groups are divided and disposed in a plurality of columns and a plurality of rows; and
the battery cooling flow path includes:
a plurality of one-way flow paths configured to cool battery groups in a plurality of columns and
a plurality of coupling flow paths configured to couple the one-way flow paths to one another to connect the plurality of one-way flow paths in series.

7. The battery cooling system according to claim 1, further comprising:
an upper battery cooling flow path disposed above the plurality of battery groups; and
a lower battery cooling flow path disposed below the plurality of battery groups, wherein
either one of the upper battery cooling flow path and the lower battery cooling flow path is the battery cooling flow path.

8. The battery cooling system according to claim 7, wherein
the upper battery cooling flow path and the lower battery cooling flow path are configured to switch a flow direction of the refrigerant.

9. The battery cooling system according to claim 7, wherein
the other of the upper battery cooling flow path and the lower battery cooling flow path is configured such that the refrigerant flows in a direction opposite to the flow direction of the refrigerant in the one battery cooling flow path.

10. The battery cooling system according to claim 8, wherein
the other of the upper battery cooling flow path and the lower battery cooling flow path includes:
the other battery cooling flow path;
a third inlet and outlet portion of the other battery cooling flow path;
a fourth inlet and outlet portion of the other battery cooling flow path;
a third supply flow path configured to connect the first outlet of the inflow-side three-way valve to the third inlet and outlet portion;
a fourth supply flow path configured to connect the second outlet of the inflow-side three-way valve to the fourth inlet and outlet portion;
a third discharge path configured to connect the first inlet of the outflow-side three-way valve to the fourth inlet and outlet portion; and
a fourth discharge path configured to connect the second inlet of the outflow-side three-way valve to the third inlet and outlet portion.
